(19) United States
(12) Patent Application Publication
(10) Pub. No.: US 2008/0098067 A1
(43) Pub. Date: Apr. 24, 2008

(54) METHOD AND SYSTEM FOR ELIMINATING TIME LOST IN INITIAL STAGES OF A WEB CONFERENCE DUE TO PARTICIPANTS NOT BEING IN-PLACE ON-TIME

(76) Inventors: Patrick Joseph O'Sullivan, Dublin (IE); Sean Callanan, Dublin (IE); Carol S. Zimmet, Boxborough, MA (US); Ruthie D. Lyle, Durham, NC (US); Gary Denner, Celbridge (IE); Cynthia E. Barber-Mingo, Westford, MA (US)

Correspondence Address: LOTUS AND RATIONAL SOFTWARE;David A. Dagg, Esq., 44 Chapin Road, Newton, MA, 02459, US

(21) Appl. No.: 11/551,668

(22) Filed: Oct. 20, 2006

(51) Int. Cl. G06F 15/16

(52) U.S. Cl. 709/204

(57) ABSTRACT

A system for eliminating the time lost in initial stages of a Web conference due to participants not being in-place on-time is disclosed. The system enables automatic steps to be taken at the server to pull conference participants into a conference based on their acceptance of an invitation to the conference. A server system provides indications of confirmed conference participants to agent software on the client systems, and activates client side agents when the a conference is about to start. The Web conference server communicates relevant conference information to each client side agent. The agent launches the user's client side browser and automatically performs any other preliminary steps that are required to join the participant to the conference. The participant user may be presented with a user interface that enables them to either accept or reject the automatic login to the conference. If the user rejects the automatic login, then indication of this rejection is passed to the server. Other information passed from the client system to the server may include an indication that no response to the accept/reject prompt was received from the user, an indication that automatic login to the conference was attempted but failed for some specified reason, indication that the participant was automatically logged in to the conference but is not at their desk, that the participant's client system is not connected to the network, or that the participant is currently active in another application or activity on their client system.

### FIELD OF THE INVENTION

The present invention relates generally to Web conferencing and on-line meeting systems, and more specifically to a method and system for eliminating time lost in the initial stages of a Web conference due to participants not being in-place on-time.

### BACKGROUND OF THE INVENTION

As it is generally known, Web conferencing software has become an important tool that is used for many purposes in a wide variety of businesses. Web conferencing enables geographically dispersed individuals to hold on-line meetings and/or provide live presentations over the Internet. In contrast to other techniques for sharing information in groups, a Web conference is a “live” or “synchronous” event. Other types of information sharing systems involve asynchronously posted messages, including those systems referred to as “forums”, “message boards”, or “bulletin boards”.

Web conferencing may be provided as a service, by a Web server system controlled by a vendor, or as a licensed product that allows organizations to install the software on their own servers. Conventional Web conferencing software permits multiple participants in multiple locations/time zones to be part of a shared Web conference.

In a Web conference, each participant typically interfaces to the conference through their own client computer system, which provides a network connection to a remote conference server. Screen sharing is a feature provided in most Web conferences. Through screen sharing all conference participants are, for example, able to see the contents of a presenter's screen.

Some common features of Web conferences include:
Application sharing, through which participants can cooperatively manipulate a shared application, e.g. a spreadsheet;
Web co-browsing, enabling multiple users to browse the Web;
Annotation, allowing a presenter to highlight or mark items on the display for all participants; and
Conference recording for later playback.

A problem with existing Web conferencing software relates to the time that is typically lost at the start of a Web Conference because all participants are not in-place, on-time. Research has shown that less than 20% of participants are in-place, on-time at the beginning of Web Conferences. Research also indicates that 75% of participants typically arrive within the first 10 minutes, and 5% either join later or just access local data, such as slides. When participants are not in-place on-time for a Web conference, time and opportunity is lost.

Some existing systems have attempted to address this issue, but in many respects have fallen short of providing a highly effective solution. For example, U.S. Pat. No. 6,363,352 of Dailey et al. (“Dailey et al.”) discloses a system and method for automatic scheduling and formation of a virtual meeting over a computer network. Dailey et al. teach scheduling a virtual meeting and automatically performing some specific actions, near the time the virtual meeting is scheduled to take place.

A first shortcoming of Dailey et al. and other similar systems is the lack of ability for a server system to operate by pulling participants into a meeting or conference, such prior systems have instead operated on a push model from the client system's desktop. For this reason and others, these prior systems have failed to provide useful information to the conference server regarding the state of each participant. Examples of information that would be desirable to have collected at the conference server include whether an attempt to automatically connect or join a participant was made and failed, whether a user's computer system has been connected but the user is not at their system, whether a user's system is not currently connected to the network and accordingly the user is likely not in the building, whether the user is currently participating in a different Web conference, whether the user is currently in another application or activity, whether the user is on a low speed connection, and other information. It would be desirable to have such information regarding specific participants made conveniently available at the Web conference server, for example as part of a pull model, where the server system operates to pull participants into a Web conference.

Another shortcoming of Dailey et al. and the like is reliance on the availability of a single host to which all other systems connect for peer-to-peer connections via that host's IP (Internet Protocol) address. Such an approach is incompatible with an enterprise computing architecture in which a server or cluster of servers provides Web conference capabilities, and in which conference participants are provided with a URL (Uniform Resource Locator) to access each conference. Prior solutions that take the approach of Dailey et al. in this regard do not accommodate operation using a distributed server topology, and do not support associating a user with their local conference server in a host-independent way.

Previous systems such as Dailey et al. also require users to manually perform authentication steps necessary to join the virtual meeting. Such steps can be time consuming, and therefore contribute to the lateness of conference participants, who may not account for the time needed to perform such steps when deciding when to start joining a meeting or conference.

In addition, Dailey et al. and similar systems provide no indication to other conference participants of whether a given participant has been automatically connected or automatically logged in to the meeting. Accordingly, using such previous solutions, assumptions regarding whether a user is actually in place during a conference are not valid until that user has somehow expressly confirmed that they are in place.

Dailey et al. and other existing systems also include no way to handle a situation in which a user has accepted multiple conflicting conference invitations. With the use of Web conferencing and the like continuously increasing, the likelihood of such conflicting scheduled events is increasing, and users will be seeking systems with features that help handle scheduling conflicts effectively.

Existing systems that follow the teachings of Dailey et al. are also lacking with regard to handling situations where a participant is disconnected from the network at the time a scheduled conference is starting. These existing systems assume IP connectivity between participating systems, and that the participant is always online. Since this is often not the case, an approach that also deals with the case of a disconnected user would be desirable.

For the above reasons and others, it would be desirable to have a new system for eliminating the time lost in initial stages of a Web conference due to participants not being in-place on-time. The new system should advantageously provide a pull model for a server system to pull participants into a conference, and provide information regarding the state of each participant to the server system. The new system should also be compatible with an enterprise computing architecture in which a server or cluster of servers provides Web conference capabilities, and in which conference participants are provided with a URL (Uniform Resource Locator) to access each conference. The new system should also assist in performing authentication and other preliminary steps for participants, reducing the time needed to join a conference. The new system should specifically provide indication to other participants as to whether a given participant has been automatically connected or automatically logged in to the conference, along with indications when these automatically connected or automatically logged in users are confirmed as physically present and in attendance The new system should also assist in handling situations where participants have accepted multiple conflicting conference invitations. And the new system should be able to operate effectively when a participant is disconnected from the network.

### SUMMARY OF THE INVENTION

In order to address the above described and other shortcomings of prior solutions, a new method and system for eliminating the time lost in initial stages of a Web conference due to participants not being in-place on-time is disclosed. Automatic steps are taken at a server system to pull conference participants into a conference based on their acceptance of the invitation to the conference. Server side application software, such as calendaring and scheduling application and Web conferencing system software, provide indications of confirmed conference participants to agent software on the client systems, and activate the client side agents when the a conference is about to start. The Web conference server communicates the URL, e-meeting password, and any other relevant conference information to each client side agent. The agent in turn launches the user's client side browser and automatically performs any other preliminary steps that are required to join the participant to the conference. In one embodiment, the participant user is then presented with a user interface that enables them to either accept or reject the automatic login to the conference. If the user rejects the automatic login, then indication of this rejection is passed to the server. Other information passed from the client system to the server may include an indication that no response to the accept/reject prompt was received from the user, an indication that automatic login to the conference was attempted but failed for some specified reason, indication that the participant was automatically logged in to the conference but is not at their desk, that the participant's client system is not connected to the network, that the participant is not currently paying attention to the conference (e.g. as indicated by a screen saver process or the like being currently active on the their client system), or that the participant is currently active in another application or activity on their client system.

In another embodiment, the preliminary steps performed may include the making and/or enforcing of recommendations with regard to the client system software used to provide the conference. For example, server software may require certain software components be installed on the client system. This requirement may arise in situations such as when recently updated server software requires that a specific browser plug-in be installed in the client system. Under those circumstances, an embodiment of the disclosed system would either request or require that the user install the plug-in, and then subsequently allow the user to join the conference. Another example of a situation in which the server may require specific software for use in participating in a conference would be when the server is experiencing problems with connections from a specific type of browser program (e.g. Internet Explorer), and accordingly requires that the client systems use another browser program (e.g. Netscape or Mozilla) to be launched on the client system for connection to the conference. Along these same lines, if the server system is experiencing certain problems at the time the conference is about to start, it may wish to provide a completely different URL from that provided in the original meeting invitation, and then this new URL would be used to connect to the conference to avoid these problems. The flexibility of providing such preliminary steps in the context of the disclosed system pulling users into a conference at a time just prior to the conference beginning is advantageous in allowing the server to take steps to avoid or correct problems that have arisen either on the server or on the client since the time at which the original invitation was sent. In an embodiment in which the URL is not sent to the participant's client system until just prior to the conference start time, there is also a potential resulting advantage in security.

A visual semantic may be provided as a user interface display object in the conference user interface to visually indicate to all participants whether specific participants have been automatically joined to the conference without their participation. This display object would disappear/change appearance in response to an indication that a participant is currently participating in and/or paying attention to the conference, for example as indicated when their Web browser program's user interface window has a Z-Order indicating that it is front-most in their display, thus indicating that they are currently at their desk and paying attention.

The disclosed system may be embodied to use programmatic hooks into a local credentials vault on the client system, and through such hooks obtain authentication information on the client system that for a client agent process that takes responsibility for automatically logging the participant in to the Web conference prior to its start.

In another aspect of the disclosed system, conflicts between the scheduled times of multiple conferences are automatically resolved based on conference priorities. Such priorities, may, for example, be determined based on prior conference activity patterns on the participant's client system.

In another aspect of the disclosed system, in the event that the client system is disconnected from the network, or in the event that the network is unavailable, the client side agent operates to launch as many components as possible that are needed for the conference on the client system. The agent then goes into a listening mode, so that when the client system is subsequently connected to the network, the conference is quickly joined.

The disclosed system may be embodied to operate in a system in which advance notice of conferences is provided, for example in the form of a meeting invitation, through which invitees can respond, for example by accepting, declining, or delegating the invitation. A URL for the conference is included in the invitation, along with a password and meeting details (e.g. a dial in number if required).

Thus there is disclosed a new system for eliminating the time lost in initial stages of a Web conference due to participants not being in-place on-time. The disclosed system advantageously provides a pull model for a server system to automatically cause participants to be joined to a conference, and to provide information regarding the participation state of each participant to the server system. The disclosed system is compatible with an enterprise computing architecture in which a server or cluster of servers provides Web conference capabilities, and in which conference participants are provided with a URL (Uniform Resource Locator) to access each conference. The disclosed system assists in performing authentication steps for participants, reducing the time needed to join a conference. The disclosed system provides indications to other participants as to whether a given participant has been automatically connected or automatically logged in to the conference, along with indications when such automatically connected or automatically logged in users are confirmed as physically present and in attendance. The disclosed system also assists in handling the situation where a user has accepted multiple conflicting conference invitations. And the disclosed system also operates effectively when a participant is disconnected from the network.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram showing components in an illustrative embodiment of the disclosed system;

FIG. 2 is another block diagram further showing components in an illustrative embodiment of the disclosed system;

FIG. 3 is a flow chart showing steps performed by a server side process in an illustrative embodiment to trigger a Web conference bootstrap process on a client system of a Web conference participant;

FIG. 4 is a flow chart showing steps performed to create a Web conference in an illustrative embodiment;

FIG. 5 is a flow chart showing steps performed in a server side process in an illustrative embodiment to pull participants into a Web conference;

FIG. 6 is a flow chart showing steps performed in a client side process in an illustrative embodiment to pull a participant into a Web conference in the event that a participant is currently online; and

FIG. 7 is a flow chart showing steps performed in a client side process in an illustrative embodiment to pull a participant into a Web conference in the event that a participant is currently off-line.

### DETAILED DESCRIPTION OF EXEMPLARY EMBODIMENTS

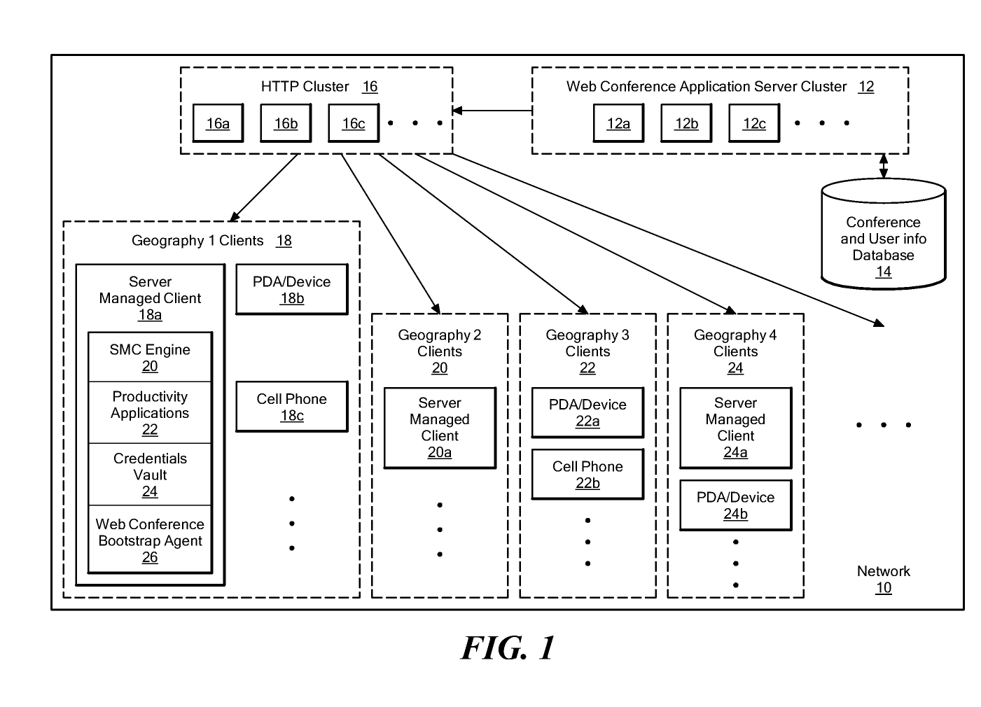

FIG. 1 is a block diagram showing components in an illustrative embodiment of the disclosed system. As shown in FIG. 1, a communication network 10 (e.g. the Internet and/or Local Area Network) interconnects systems including a Web Conference Application Server Cluster 12, an HTTP Cluster 16, and client systems for potentially multiple geographies, shown for purposes of illustration as including Geography 1 Clients 18, Geography 2 Clients 20, Geography 3 Clients 22, and Geography 4 Clients 24. A Conference and User Information Database 14 is shown communicably coupled to the Web Conference Application Server Cluster 12. The Web Conference Application Server Cluster 12 includes one or more server computer systems operating to execute server application programs including a Web conference application, and shown for purposes of illustration as including server systems 12a, 12b, 12c, etc. The HTTP Cluster 16 includes one or more server computer systems operating to provide HTTP (HyperText Transfer Protocol) functions between the Web Conference Application Server Cluster 12 and the client systems, and is shown for purposes of illustration as including server systems 16a, 16b, 16c, etc

The disclosed system may be embodied for use with any specific type of client system, including but not limited to desktop computer systems, PDAs (Personal Digital Assistants), cell phones, tablet PCs, or any other appropriate client device. The illustrative example of FIG. 1 shows Geography 1 Clients 18 including a Server Managed Client 18a, a PDA 18b, and Cell Phone 18c, Geography 2 Clients 20 including a Server Managed Client 20a, Geography 3 Clients 22 including a PDA 22a and Cell Phone 22b, and Geography 4 Clients 4 including Server Managed Client 24a and PDA 24b.

In one embodiment, the disclosed system operates through a server managed client model, as illustrated by the Server Managed Client 18a in FIG. 1. As shown in FIG. 1, the Server Managed Client 18a executes software components including a Server Managed Client (SMC) Engine 20, Productivity Applications 22, Credentials Vault 24, and Web Conference Bootstrap Agent 26.

Computer systems in the server clusters 16 and 12, as well as in the client systems 18, 20, 22 and 24, may, for example, each consist of at least one processor, program storage, such as memory, for storing program code executable on the processor, one or more input/output devices and/or interfaces, such as data communication and/or peripheral devices and/or interfaces, and may each further include appropriate operating system software.

During operation of the embodiment of the disclosed system shown FIG. 1, time lost in initial stages of a Web conference due to tardiness of participants is eliminated, as further described below.

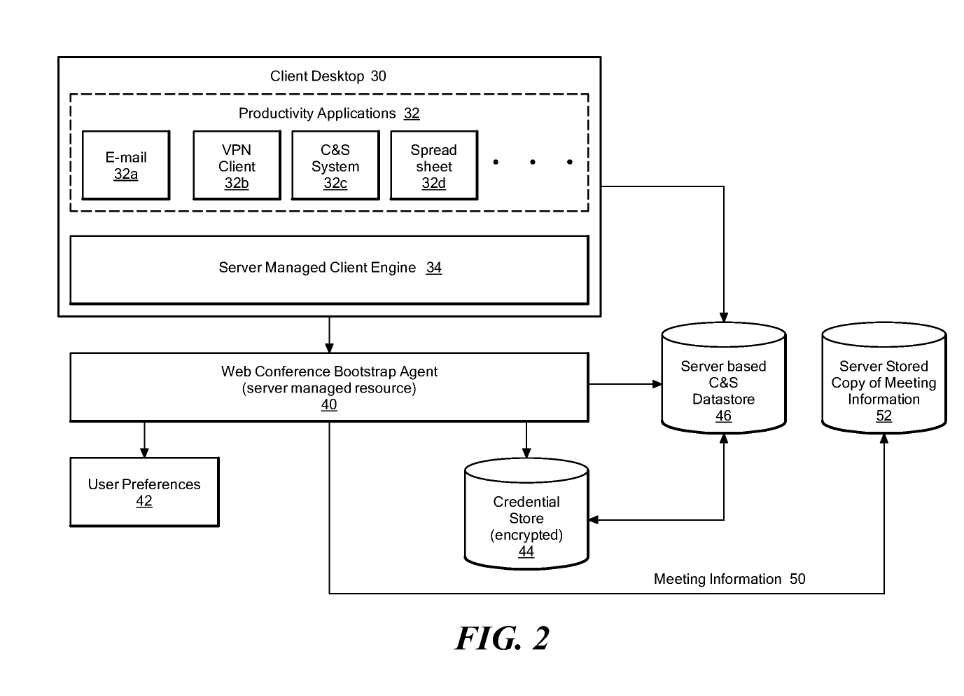

FIG. 2 is a block diagram further showing components in an illustrative embodiment of the disclosed system. As shown in FIG. 2, the applications represented in a Client Desktop 30, which is a user interface construct providing user access to applications in a primary display screen of a graphical user interface to a client computer system, include Productivity Applications 32 and a Server Managed Client Engine 34. The Productivity Applications 32 may, for example, include an E-mail application 32a, a VPN (Virtual Private Network) Client application 32b, a Calendaring and Scheduling system 32d, and a Spreadsheet Application 32d, and others as may be appropriate for a given embodiment.

FIG. 2 further shows a Web Conference Bootstrap Agent 40. The Web Conference Bootstrap Agent 40 of FIG. 2 is a server managed resource, for example managed by a remote server system through the Server Managed Client Engine 40. The Web Conference Bootstrap Agent 40 is operable to access User Preferences 42, and a Credential Store 44 (which is encrypted). Both the User Preferences 42 and the Credential Store 44 are stored on the client computer system. The Productivity Applications 32 and Server Managed Client 34 in the Client Desktop 30, as well as the Web Conference Bootstrap Agent 40 and Credential Store 44 are communicable with a Server Based Calendaring and Scheduling Datastore 46. The Server Based Calendaring and Scheduling Datastore 46 may, for example, provide indications of which invited participants for a Web conference have accepted their invitations, and which of the invited participants for a Web conference have declined their invitations. Similarly, such indications of whether a participant accepts or rejections a Web conference invitation may be stored to the Server Based Calendaring and Scheduling Datastore 46 from client side applications, such as the Calendaring and Scheduling system software 32c.

Further as shown in FIG. 2, the Web Conference Bootstrap Agent 40 is operable to store Meeting Information 50 into a Server Copy of Meeting Information 52. The Meeting Information 50 stored from the Bootstrap Agent 40 to the Server Stored Copy of Meeting Information 52 may include information indicating whether a user has accepted or rejected being automatically joined to a given Web conference, an indication that automatic login to a conference was attempted but failed for some specified reason, an indication that a participant was automatically logged in to the conference but is not currently at their desk, an indication that the participant's client system is not connected to the network, an indication of the speed of the connection that the participant uses to access the conference, and/or an indication that the participant is currently active in another application or activity on their client system.

In one embodiment of the disclosed system, the Client Desktop 30, Web Conference Bootstrap Agent 40, User Preferences 42, and Credential Store 44 are provided as part of one of the client systems 18, 20, 22 or 24 shown in FIG. 1. Similarly, in such an embodiment, the Server Based Calendaring and Scheduling Datastore 46 and Server Stored Copy of Meeting Information 52 are provided as part of the Web Conference Application Server Cluster 12, for example at least partly within the Conference and User Information Database 14.

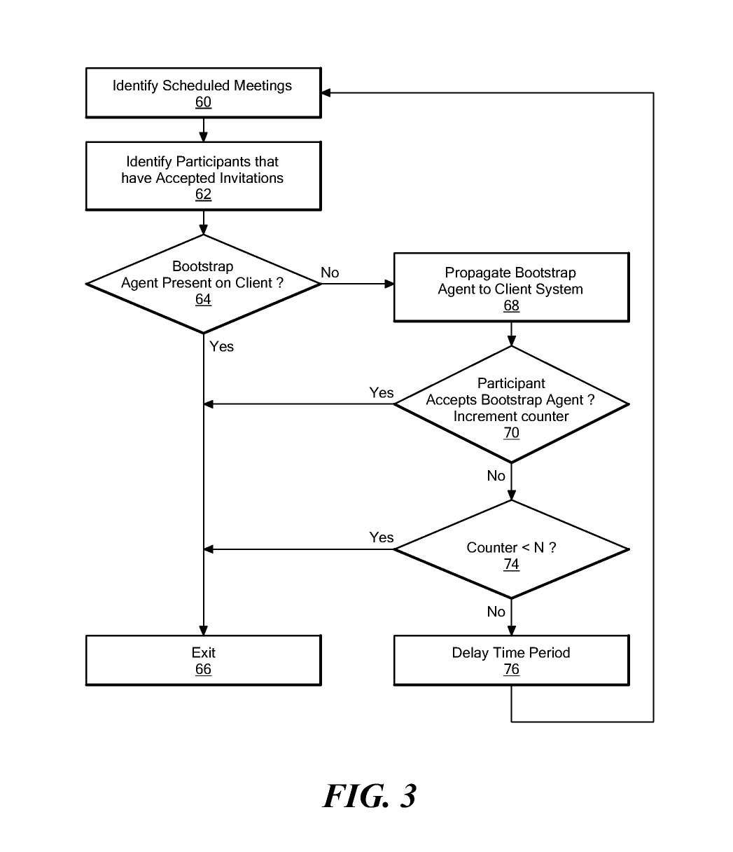

FIG. 3 is a flow chart showing steps performed by a server side process in an illustrative embodiment to trigger a Web conference bootstrap process on a client system of a Web conference participant. The steps of FIG. 3 ensure that a Web conference bootstrap agent is in place on each of the client systems for accepted participants in a Web conference, so the agent can be used by a server system to pull those accepted participants into the Web conference. The steps of FIG. 3 may, for example, be performed by a process executing on the Web Conference Application Server Cluster 12 of FIG. 1.

As shown in FIG. 3, at step 60, the disclosed system operates to identify scheduled meetings, for example through operation of a calendaring and scheduling software application program. At step 62, the disclosed system identifies participants that have accepted invitations to at least one of the scheduled meetings identified at step 60. At step 64 a determination is made as to whether a Web conference bootstrap agent is present on a client computer system associated with a selected one of those participants identified at step 62. If so, then the bootstrap agent is in place, and can be triggered by the server system to pull the participant for that client system into the Web conference, and accordingly step 64 is in that case followed by step 66, in which the process exits. Otherwise, step 64 is followed by step 68, in which the Web conference bootstrap agent is propagated to the client system.

The participant may be given the option of accepting the bootstrap agent itself at step 70. In one embodiment, a counter is incremented at step 70 to count the number of times an attempt has been made to get the participant to accept the bootstrap agent. In such an embodiment, the number of times such an attempt is made is counted to limit the number of times an attempt is made to get the participant to accept the bootstrap agent, since the participant may be away, and may not be able to accept the bootstrap agent. If the participant accepts the bootstrap agent at step 70, then the bootstrap agent can be triggered by the server system to pull the user into the Web conference, and accordingly step 70 is followed by step 66, in which the process exits. Otherwise, if the participant does not accept the bootstrap agent at step 70, then the counter is checked at step 74 in order to determine whether the configured limit “N” to the number of attempts to get the participant to accept the bootstrap agent has been reached. If the counter has expired, then step 74 is followed by step 66, in which the process exits. Otherwise, following a delay period at step 76, step 74 is followed by step 60, and the process of FIG. 3 are repeated.

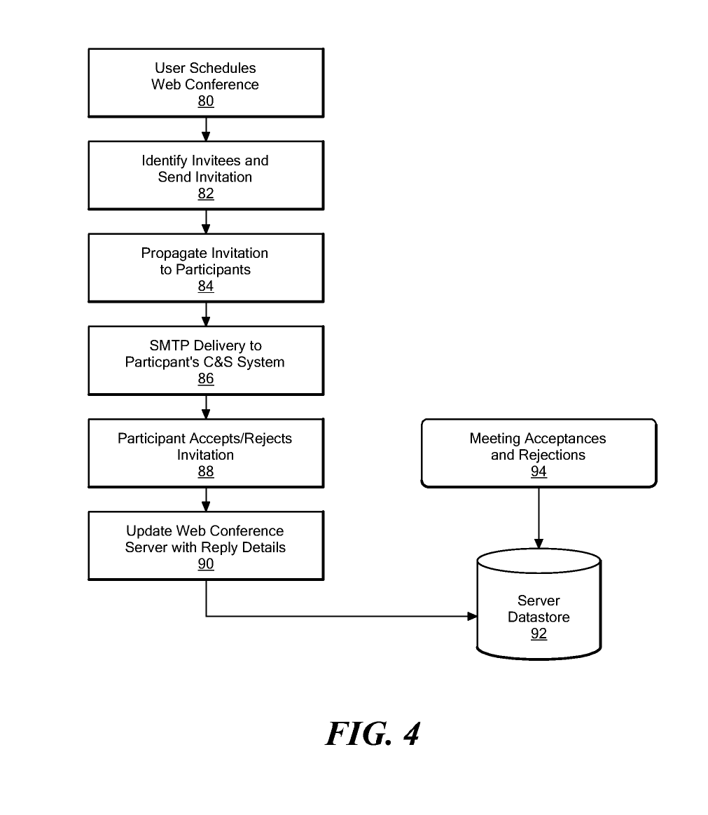

FIG. 4 is a flow chart showing steps performed to create a Web conference in an illustrative embodiment. As shown in FIG. 4, at step 80 a user schedules a Web conference, for example using client software such as the calendaring and scheduling software 32c shown in FIG. 2 to select a time for the conference and other related meeting information (e.g. a dial up number if required). The user goes on to identify the invitees for the Web conference, and to send an invitation to those invitees at step 82. The invitations are propagated to the participants at step 84, and in one embodiment at step 86, there is delivery by way of SMTP (Simple Message Transfer Protocol) to each participant's calendaring and scheduling system. At step 88, each participant is able to accept or reject the invitation. At step 90 the Web conference server, such as provided by the Web Conference Application Server Cluster 12 of FIG. 1, is updated with reply details, including indications of whether each invited meeting participant has accepted or rejected the invitation. As a result of step 90, the Meeting Acceptances and Rejections 94 are stored in the Server Datastore 92, which may correspond to the Conference and User Information Database 14 shown in FIG. 1.

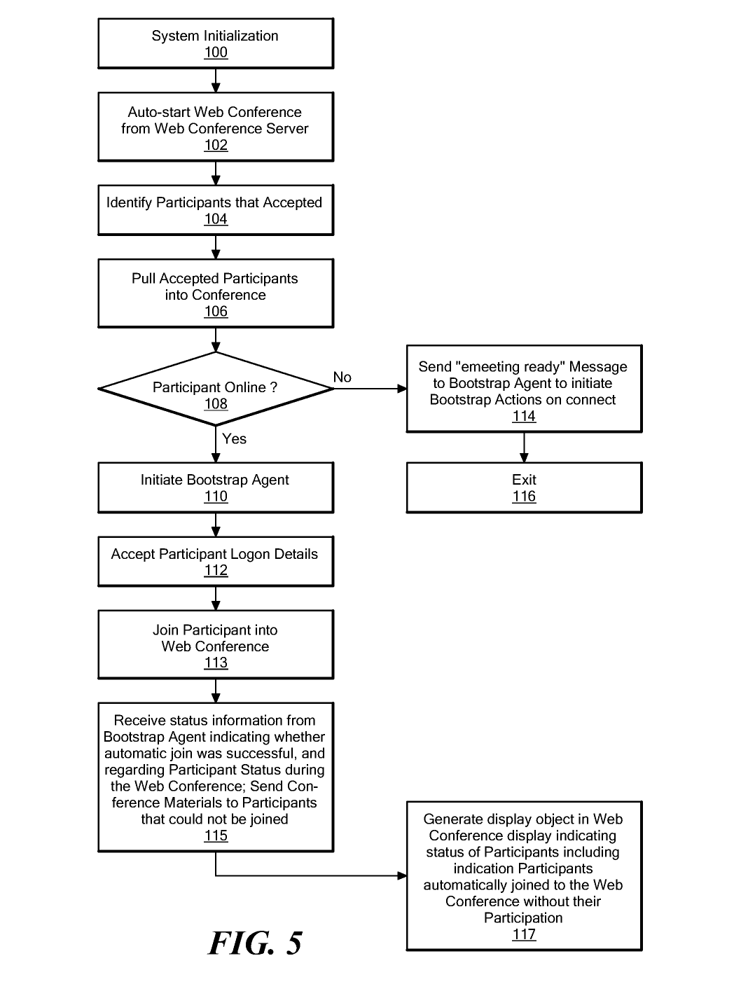

FIG. 5 is a flow chart showing steps performed in a server side process in an illustrative embodiment to pull participants into a Web conference. The steps of FIG. 5 may, for example, be performed by a software process executing on the Web Conference Application Server Cluster 12 shown in FIG. 1.

As shown in FIG. 5, at step 100 the system is initialized. Subsequently the server side process determines that a Web conference is going to begin shortly, and at step 102 begins auto-starting a Web conference from the Web conference server system. At step 104 the disclosed system identifies the participants that have accepted invitations to the Web conference that is about to start, and then at step 106 begin to pull participants that have accepted their invitations into the Web conference, prior to the start time of the conference.

At step 108, the server side process determines whether each of the participants that have accepted invitations to the Web conference are currently online. When a participant that accepted the invitation is found to be online, then step 108 is followed by step 110. Otherwise, if the participant is not currently online, then step 108 is followed by step 114.

At step 110, the server side process initiates execution of a bootstrap agent previously loaded onto the client system of the participant that is currently online. Step 110 should be performed by the server software at a time sufficiently prior to the start of the Web conference (e.g. several minutes prior to the conference) to allow the client side process to auto-join the participant to the conference by the time the conference begins.

In one embodiment, at step 110, the server side process provides information to the client system that enables the bootstrap agent to perform preliminary steps to be performed, including information to support the making and/or enforcing of recommendations with regard to the client system software used to provide the conference. For example, as part of such information conveyed from the server process to the client system at step 110, the server software may indicate that certain software components must be installed on the client system. For example, certain client side software components may be required when the server software was recently updated, as when recently updated server software requires that a specific browser plug-in be installed on the client system. This embodiment of the disclosed system would, under such circumstances, cause the bootstrap agent or the like to either request or require that the user install the plug-in, and then subsequently allow the user to join the conference. Installation or upgrading of specific client software could be made a requirement for the participant to join the conference. Another example of a situation in which the server may require specific software for use in participating in a conference would be when the server is experiencing problems with connections from a specific type of browser program (e.g. Internet Explorer), and accordingly requires that the bootstrap agent use another browser program (e.g. Netscape or Mozilla) to be launched on the client system for connection to the conference. Along these same lines, if the server system is experiencing certain problems at the time the conference is about to start, it may wish to provide at step 110 a completely different URL from that provided in the original meeting invitation, and then this new URL would be used by the bootstrap agent to connect the participant to the conference to avoid these problems.

The bootstrap agent then obtains information necessary to log the participant into the Web conference, and that information is received by the server side process at step 112. The server side process can then join the participant into the Web conference using the logon information received at step 112 at step 113.

At step 115, the server side process receives status information from the bootstrap agent, including indication of whether the automatic join attempted by the bootstrap agent was successful. If the attempt to automatically join the participant to the Web conference was not successful, then an indication of why the automatic join failed is provided to the server system. Information regarding participant status during the Web conference is also passed from the client process to the server side process at step 115. Such information may, for example, include indications of whether the participant is currently participating in the conference. For example, whether a participant is currently participating in a conference may be determined by checking whether their Web browser program's user interface window presenting the conference has a Z-Order indicating that it is front-most in their display, thus indicating that they are currently at their desk and paying attention to the conference. Similarly, a participant may be determined to not be currently paying attention to a conference based on a detection by the client process that a screen saver process or the like is currently active on the client system, and indication of such current participant status accordingly passed from client side process to the server side process.

The information received by the server at step 115 may include other information regarding the status of the participant, such as an indication of the connection speed at which the participant will be accessing the conference. Alternatively, the connection speed of a given participant may be derived by the server. For example, an approximate or likely connection speed of a participant may be extrapolated by the server based on measurements of the time between steps within a multi-step process through which the participant joins the conference, or similarly from a measurement of the round trip time for contacting the participant's client computer system while pulling the participant into the conference.

In the event that a participant could not be joined to the conference, such status would be returned to the server system at step 115. In response to such a failure, the present system may be embodied to automatically send the non-joined participant conference materials via email. This feature may, for example, be advantageous to participants that are unable to connect to the conference due to a poorly functioning network, but still have access to email and telephone.

At step 117, the server side process generates a display object in Web conference display for participants in the Web conference indicating the current status of participants in the Web conference, based on the information received at step 115. Accordingly, the display object generated at step 117 includes an indication of those participants automatically joined to the Web conference without their participation. The display object generated at step 117 disappears/changes appearance in response to an indication received from the client side bootstrap agent that a participant automatically joined without their participation has started or is currently participating in the conference, for example as indicated when their Web browser program's user interface window has a Z-Order indicating that it is front-most in their display, thus indicating that they are currently at their desk and paying attention. Examples of a display object generated at step 117 include an graphical icon visually depicting a user looking at a computer to show that a participant is currently present and paying attention, which is negated (e.g. by displaying a diagonal line through the icon) in response to an indication that the participant is not present and/or not paying attention.

At step 114, in the event that the participant is not currently online, the server side process sends a message to the bootstrap agent previously loaded onto the client system of the participant, where the message indicates that the Web conference is ready to start, and instructing the bootstrap agent to initiate bootstrap actions causing the participant to be automatically joined to the Web conference upon detection that the participant has come online. Next, at step 116, the server side process exits, leaving responsibility for auto-joining the participant into the Web conference to the bootstrap agent running on the client system.

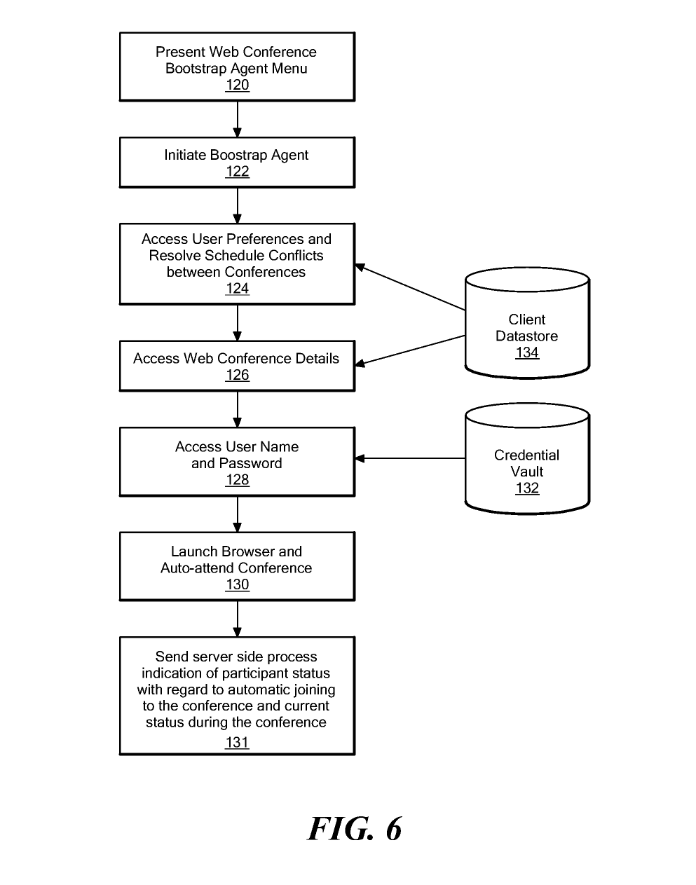

FIG. 6 is a flow chart showing steps performed in a client side process in an illustrative embodiment to respond to a server process that pulls a participant into a Web conference in the event that a participant is currently online. The steps of FIG. 6 may, for example, be performed by a bootstrap agent software process executing on one of the clients 18, 20, 22, and 24 shown in FIG. 1. The steps 122 and following shown in FIG. 6 may, for example, be performed in response to receipt of a message from a server side process, such as in connection with step 110 of FIG. 5.

As shown in FIG. 6, at step 120, the client side presents the participant with a Web Conference Bootstrap Agent Menu, for example through a graphical user interface or the like provided on the client system. Such a menu may enable the participant to accept or reject being automatically joined to a Web conference. Assuming that the participant has accepted being automatically joined to the Web conference at step 120, if such acceptance is required by a given embodiment, at step 122 the client side process receives an initiate message from a client side process, indicating that the bootstrap agent is to automatically join the participant to the Web conference. In order to do so, the client side process may check user preferences information at step 124, in order to determine how the participant wishes the automatic joining to be performed. The disclosed system further operates at step 124 to detect and resolve conflicts between the scheduled times of multiple conferences. The resolutions of such scheduling conflicts are automatically determined based on conference priorities. Conference priorities may, for example, be determined based on prior conference activity patterns recorded on the participant's client system.

At step 126, the client side process operates to obtain details about the Web conference that is about to begin, such as a URL associated with the Web conference. Both the user preferences information obtained at step 124, and the details about the Web conference obtained at step 126, are obtained from a Client Datastore 134, which may include the User Preferences 42 shown in FIG. 2.

At step 128, the client side process obtains the user name and password required for the participant to join the Web conference. The user name and password are obtained from the Credential Vault 132, which corresponds to the Credential Store 44 of FIG. 2. The client side process then operates at step 130 to launch a browser process and/or any other applications(s) that may be needed to participate in the Web conference, in a manner consistent with the user preferences obtained at step 124. The client side process further operates at step 130 to load the URL associated with the Web conference into the address field of the browser program. Further at step 130, the client side process performs any other actions needed to auto-attend the Web conference, such as providing the username and password required for the conference to the Web conference application in order to login to the Web conference.

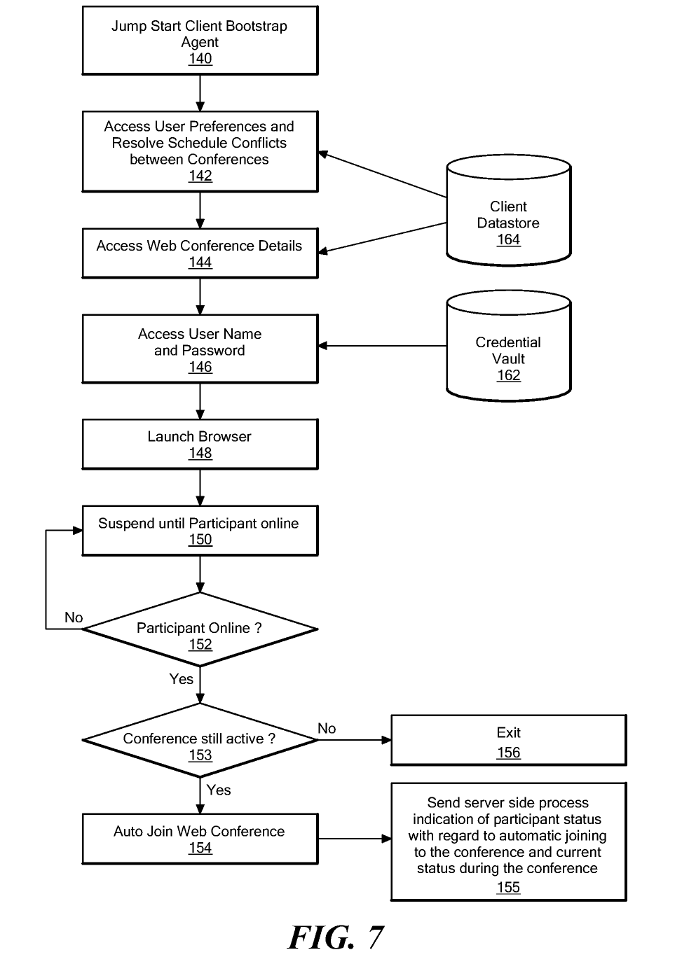

FIG. 7 is a flow chart showing steps performed in a client side process in an illustrative embodiment to pull a participant into a Web conference in the event that a participant is currently off-line. The steps of FIG. 6 may, for example, be performed by a bootstrap agent software process executing on one of the clients 18, 20, 22, and 24 shown in FIG. 1. Some or all of the actions performed in the steps shown in FIG. 7 may be performed in response to receipt of the message sent to the client system from the server side process in step 114 of FIG. 5. For example, step 140, in which the client side process is jump started as part of the bootstrap agent, and the steps that follow, may be responsive to receipt of the message sent from the server side process in step 114 of FIG. 5.

Following step 140, at step 142, the client side process accesses user preferences from the Client Datastore 164, to determine in order to determine how the participant wishes the automatic joining to be performed. The disclosed system further operates at step 142 to detect and resolve conflicts between the scheduled times of multiple conferences. As noted above, the resolutions of such scheduling conflicts are automatically determined based on conference priorities. Similar to the operation of step 124 in FIG. 6, conference priorities may, for example, be determined based on prior conference activity patterns recorded on the participant's client system.

At step 144, the client side process operates to obtain details about the Web conference that is about to begin, such as a URL associated with the Web conference. Both the user preferences information obtained at step 142, and the details about the Web conference obtained at step 144, are obtained from a Client Datastore 164, which may include the User Preferences 42 shown in FIG. 2.

At step 146, the client side process obtains the user name and password required for the participant to join the Web conference. The user name and password are obtained from the Credential Vault 162, which corresponds to the Credential Store 44 of FIG. 2. The client side process then operates at step 148 to launch a browser process and/or any other applications(s) that may be needed to participate in the Web conference, in a manner consistent with the user preferences obtained at step 124.

At step 150, the client side process suspends its operation until the participant is online. The client side process remains suspended until a determination is made at step 152 that the participant has become online. In that event, at step 153, a determination is made as to whether the Web conference is still active. If not, then the client side process exits at step 156. Otherwise, if the participant is auto-joined to the Web conference at step 154. The client side process operates at step 154 to load the URL associated with the Web conference into the address field of the browser program launched at step 148. Further at step 154, the client side process performs any other actions needed to auto-attend the Web conference, such as providing the username and password required for the conference to the Web conference application in order to login to the Web conference.

The disclosed system can take the form of an entirely software embodiment, an entirely hardware embodiment, or an embodiment containing both software and hardware elements. The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

We claim:

1. A method for eliminating the time lost in initial stages of a Web conference due to participants not being in-place on-time, comprising:
pulling, by a server system process, a Web conference participant into a previously scheduled Web conference, wherein said pulling includes activating a client system agent process at a point in time prior to a time at which said Web conference is scheduled to start, wherein said activating includes sending information from said server system process to said client system agent that is needed to join a conference participant to said Web conference; and
automatically joining said conference participant to said Web conference, by said client system agent process, wherein said automatically joining includes performing preliminary steps needed to join said conference participant to said Web conference.

2. The method of claim 1, wherein said pulling is responsive to said conference participant having accepted a previously received invitation regarding said Web conference.

3. The method of claim 2, wherein said system process provides said client system agent process with conference information including a pointer to said Web conference.

4. The method of claim 3, wherein said pointer to said Web conference comprises a Uniform Resource Locator (URL).

5. The method of claim 4, wherein said conference information further comprises a conference password.

6. The method of claim 5, wherein said automatically joining said conference participant to said Web conference further comprises launching a Web browser program on said client system.

7. The method of claim 6, wherein said automatically joining said conference participant to said Web conference further comprises presenting a user interface prompt to said conference participant, wherein said user interface prompt enables said conference participant to indicate whether they accept being automatically joined to said Web conference.

8. The method of claim 7, further comprising:
sending indication from said client system to said server system of whether said conference participant has accepted being automatically joined to said Web conference to said server system process.

9. The method of claim 7, further comprising:
sending indication from said client system to said server system that said conference participant did not respond to said user interface prompt to said server system process.

10. The method of claim 6, further comprising:
sending indication from said client system to said server system that said automatically joining said conference participant to said Web conference failed for a specified reason.

11. The method of claim 6, further comprising:
sending indication from said client system to said server system that said conference participant has been automatically joined to said Web conference but is not at their desk.

12. The method of claim 6, further comprising:
detecting and storing indication in said server system that said client system is not connected to a communication network connecting said client system and said server system.

13. The method of claim 6, further comprising:
sending indication from said client system to said server system that said conference participant is currently active in another Web conference.

14. The method of claim 6, further comprising:
sending indication from said client system to said server system that said conference participant is currently active in another application.

15. The method of claim 6, further comprising:
providing a participant status display object within a user interface display for said Web conference, wherein said participant status display object is operable to provide a visual indication of whether said conference participant was automatically joined to said Web conference with their participation.

16. The method of claim 6, wherein said participant status display object is further operable to provide a visual indication of whether said conference participant is currently participating in said Web conference.

17. The method of claim 16, further comprising determining said conference participant is currently participating in said Web conference responsive to determining that a user interface display window presenting said Web browser program is located at the top of a user interface for said conference participant.

18. The method of claim 6, wherein said automatically joining said Web conference further comprises:
obtaining authentication credentials for said conference participant and authenticating said conference participant as necessary to join said Web conference.

19. The method of claim 1, further comprising:
detecting a conflict between multiple Web conferences; and
determining a priority associated with each of said multiple conflicting Web conferences in response to previous activities of said conference participant on said client system.

20. The method of claim 1, further comprising:
in the event said client system is disconnected from a network providing communication between said server system and said client system at said time prior to said time at which said Web conference is scheduled to start, performing steps by said client system agent at said client system to join said Web conference; and
going into a listening mode by said client system agent at said client system such that said conference participant can be quickly automatically joined to said Web conference upon detection that said client system has become re-connected to said network providing communication between said server system and said client system.

21. A system including a computer readable medium, said computer readable medium having stored therein program code for eliminating the time lost in initial stages of a Web conference due to participants not being in-place on-time, said program code comprising:
program code for pulling, by a server system process, a Web conference participant into a previously scheduled Web conference, wherein said pulling includes activating a client system agent process at a point in time prior to a time at which said Web conference is scheduled to start, wherein said activating includes sending information from said server system process to said client system agent that is needed to join a conference participant to said Web conference; and
program code for automatically joining said conference participant to said Web conference, by said client system agent process, wherein said automatically joining includes performing preliminary steps needed to join said conference participant to said Web conference.

22. A computer program product including a computer readable medium, said computer readable medium having stored thereon program code for eliminating the time lost in initial stages of a Web conference due to participants not being in-place on-time, said program code comprising:
program code for pulling, by a server system process, a Web conference participant into a previously scheduled Web conference, wherein said pulling includes activating a client system agent process at a point in time prior to a time at which said Web conference is scheduled to start, wherein said activating includes sending information from said server system process to said client system agent that is needed to join a conference participant to said Web conference; and
program code for automatically joining said conference participant to said Web conference, by said client system agent process, wherein said automatically joining includes performing preliminary steps needed to join said conference participant to said Web conference.

23. A data signal embodied in a carrier wave, said computer data signal having stored thereon program code for eliminating the time lost in initial stages of a Web conference due to participants not being in-place on-time, said program code comprising:
program code for pulling, by a server system process, a Web conference participant into a previously scheduled Web conference, wherein said pulling includes activating a client system agent process at a point in time prior to a time at which said Web conference is scheduled to start, wherein said activating includes sending information from said server system process to said client system agent that is needed to join a conference participant to said Web conference; and
program code for automatically joining said conference participant to said Web conference, by said client system agent process, wherein said automatically joining includes performing preliminary steps needed to join said conference participant to said Web conference

24. A system for eliminating the time lost in initial stages of a Web conference due to participants not being in-place on-time, comprising:
means for pulling, by a server system process, a Web conference participant into a previously scheduled Web conference, wherein said pulling includes activating a client system agent process at a point in time prior to a time at which said Web conference is scheduled to start, wherein said activating includes sending information from said server system process to said client system agent that is needed to join a conference participant to said Web conference; and
means for automatically joining said conference participant to said Web conference, by said client system agent process, wherein said automatically joining includes performing preliminary steps needed to join said conference participant to said Web conference.
